(19) United States
(12) Patent Application Publication
(10) Pub. No.: US 2022/0266377 A1
(43) Pub. Date: Aug. 25, 2022

(54) UPSET TELEMETRY TOOL JOINT AND METHOD

(71) Applicant: Joe Fox, Spanish Fork, UT (US)

(72) Inventor: Joe Fox, Spanish Fork, UT (US)

(21) Appl. No.: 17/742,015

(22) Filed: May 11, 2022

(51) Int. Cl. B23K 20/12

(52) U.S. Cl. CPC B23K 20/129; E21B 17/046

(57) ABSTRACT

A drill string tool comprising a tube comprising a bore and a bore wall having externally and internally upset end portions in the bore wall. The upset end portions comprising one or more axial grooves in the bore wall open to the bore of the tube. The upset end portions further comprising a conical weld surface comprising an annular shoulder. The one or more axial grooves may be formed in the upset portions subsequent to forming the internal upset. Or, the axial grooves may be formed using a die and an internal upset mandrel comprising one or more axial lobes when the internal upset is formed in the bore wall. The upset end portions of the tube may be attached by friction welding to pin end and box end tool joints. The pin end and box end tools joints may comprise a conical weld surface comprising an annular shoulder.

### RELATED APPLICATIONS

This application presents a modification of U.S. Pat. No. 5,184,495, to Chunn et al., entitled Method of Internally and Externally Upsetting the End of a Metal Tube, issued Feb. 9, 1993. Said patent is incorporated herein by this reference for all that it teaches.

Pending U.S. patent application Ser. No. 17/734,004, to Fox, entitled Drill Pipe with Fluted Gun Drilled Passageway, filed Apr. 30, 2022, is incorporated herein by this reference for all that it teaches.

### BACKGROUND

This invention relates to a method of internally and externally upsetting the ends of a metal tube to which tool joints are to be welded to form a joint of drill pipe. This application is a modification of the above '495 reference. The teaching of the '495 reference are applicable to this disclosure in so far as they are not modified by FIGS. 1-5 and the text related thereto. The background, summary, and detailed description are largely taken from said reference. The teachings of '004 reference is also applicable to this application.

One reason the ends of the metal tube are upset is to provide a thicker wall for welding to the tool joint and thereby provide a stronger connection between the tool joint and the tube. The end of the tube can be externally upset, internally upset, or both externally and internally upset depending upon the tool joint to be attached. Today most drill pipe tubes are both internally and externally upset to obtain the thickest possible wall for welding to the tool joint.

The American Petroleum Institute (API) sets standards for the upsets on all sizes of drill pipe and the approximate shape required by API for 5″ drill pipe, where the tube is both internally and externally upset, is shown in (Prior Art) FIG. 8. (Prior Art) FIG. 10 is a graph plotting drill pipe failures and where on the joint they occurred. Most failures occurred between 15″ to 25″ from the end of the box and between about 10″ to 20″ from the end of the pin. It is generally agreed in the industry that the failures occur at this point because of the change in section between the upset portion of the tube and the nominal wall of the tube. In other words, it is the relatively large change in the thickness of the pipe through the short transition section A of (Prior Art) FIG. 8 which causes high stress concentrations in the area marked “B”.

Consequently, there has been an effort to upset the end of the drill pipe tube in such a way as to lengthen the internal conical transition section between the relatively thick internal cylindrical section and the nominal tube wall. The length of this transition section measured along the longitudinal axis of the tube is called “Miu”.

In Japanese patent publication SHO61(1986)-46212, a method of internally and externally upsetting the end of a tube is described. It involves three steps. In the first step, the tube is externally upset to have a cylindrical section with a thickened wall that is connected to the tube by a conically shaped section.

In the second step, the externally upset material from the first step is forced inwardly until the outside diameter of the tube is returned to its original diameter. The upset metal from the first step that is moved inwardly forms a thick cylindrical internal section connected to the tube by a conical section. In the third step, the end is externally upset so that the end is both internally and externally upset with conical sections connecting the internal and external cylindrical sections of the upset to the tube.

A modification of the 46212 process is described in U.S. Pat. No. 4,845,972 that issued Jul. 11, 1989 and assigned to Nippon Steel Corporation of Japan. The '972 patent discusses the 46212 publication and shows two figures of that publication as prior art. These are (Prior Art) FIGS. 6B and 6C. The '972 patent says that the method of the 46212 publication makes it difficult to control the shape of the internal upset portion that is not restrained by the mandrel and that underfilling and buckling are apt to occur at that portion. Underfill and buckling would make the method of upsetting undesirable and impractical. The '972 patent goes on to say that the forging method disclosed therein ('972) is superior to the 46212 forging process because in the former “the metal of said pipe is displaced inwardly for thickening after shaping by external upset forging whereas in the 46212 disclosure all of the metal displaced in the external upset operation or step is returned inwardly so that in the final step the outside shape of the upset must be formed by again moving metal outwardly.

### SUMMARY OF THE INVENTION

The following portion of the summary description applies to FIGS. 1-5. FIGS. 1-5 present different diagrammatic views of embodiments of the present invention.

The present invention concerns a drill string tool and method for producing same. The method may include providing a tube comprising a central bore and a central bore wall suitable for use in a drill string tool, such as a drill pipe, riser, heavy weight drill pipe, drill collar, and downhole tools that may be found in the bottom hole assembly including drill bits connected to the drill string. Such tools may be fitted for wired telemetry drill pipe applications using inductive couplers and armored cables running the length of the individual drill string tools connecting the downhole tools with the surface electronics.

The tube may comprise forming an annular external upset in the bore wall of the opposing end portions of the tube. Additionally, the method may include forming an annular internal upset in the bore wall radially opposite the external upset. The internal upset may comprise one or more axial grooves. The axial grooves in the bore wall may be open to the bore of the tube. The axial grooves may reduce the time and expense of manufacturing the tool. The axial grooves may provide a pathway for an armored cable (not shown) to enter the bore of the tube as the armored cable exits the passageway of a tool joint that may be attached to the tube.

The internal upset in the bore wall may comprise a conical weld surface comprising an annular shoulder. The conical weld surface and shoulder may aid in the attachment of the tube to the tool joints. The conical weld surface and the annular shoulder may increase the strength of the weld connection between the tool joints and the upset portion of the tube. The conical weld surface combined with the annular shoulder may also promote competent friction welding and reduce the amount of weld flash produced in the welding process. The conical weld surface may intersect the bore and bore wall, the internal and external upset portions of the tube, and the one or more axial grooves.

An embodiment of the disclosed tool may include providing a pin end tool joint comprising a primary annular shoulder and an annular secondary shoulder. The shoulder may comprise an annular groove communicating with an axial passageway within the tool joint. The axial passageway may lead to the axial groove providing access to the bore of the tube.

The pin end tool joint may further comprise a conical weld surface comprising an annular shoulder. The respective conical weld surfaces may mate with the respective conical weld surfaces of the upset portions of the tube as the tube is attached to the pin end tool joint.

The tube may comprise a pin end tool joint on one end of the tube and box end tool joint on the opposite end of the tube. The respective tool joints aid in incorporating the downhole tool in a tool string. The box end tool joint may comprise a primary annular shoulder and an annular secondary shoulder comprising an annular groove communicating with an axial passageway within the tool joint. The annular groove and the axial passageway may facilitate the addition of wired drill pipe components to the downhole tool. Accordingly, the annular grooves may house and inductive coupler system for the electromagnetic transfer of power and data between connected tool string components. The axial passageway may provide a pathway for an armored cable to run from the inductive coupler system to a like system at the opposite end of the drill string tool.

The box end tool joint further may comprise a conical weld surface comprising an annular shoulder. The conical weld surfaces may aid in strengthening the attachment of the tool joint to the upset portion of the tube. The respective conical weld surfaces may promote the attachment of the tool joint to the tube. The conical weld surfaces may reduce the amount of flash produced in the attachment process.

The respective tool joints may be attached along the conical weld surfaces and the annular shoulders to the respective upset end portions of the tube in such a manner that the axial passageways are aligned with the one or more open grooves in the upset end portions of the tube. The alignment of the axial passageways with the grooves may aid in the manufacturer of the tool. The alignment may reduce the amount time and expense otherwise associated with gun drilling an extended length passageway in the bore wall after the respective tool joints are welded to tube. In the event that the axial passageways are not aligned with the groove, the presence of the axial passageways may still reduce the cost of manufacturing by eliminating the substantial amount of time and expense required in gun drilling through tool joint. Also, the axial passageway may provide a guide for drilling through the upset potion of the tube.

In aligning the axial passageways with the grooves while the respective upset end portions of the tube are friction welded along the conical weld surfaces and respective shoulders to the respective tool joints, the friction welding may be selectively terminated when the passageways and the respective one or more grooves are aligned. The selective termination of the welding process may be achieved by monitoring the rotation and time of rotation of the tube and tool joint, the pressure required in the process, as well as the color of the weld surfaces. The color of the weld surfaces may indicate when the weld process is sufficiently complete to terminate the process. The production of weld flash may also indicate when the weld process may be completed.

The one or more grooves in the upset end portions of the tube may be formed by machining the internal upset prior to the attachment of the tube to the tool joints. Machining the internal upset may include milling, drilling, broaching, grinding, sawing, or a combination thereof.

Alternatively, the one or more grooves may be formed in the internal upset portion of the tube when the upset is forged. For example, an assembly comprising a tube comprising externally upset end portions, an internal upset die, and an internal upset mandrel comprising one or more axial lobes may be used to form the one or more axial grooves when the internal upset is forged. The external upset portion of the tube may be inserted into the internal upset die and the mandrel may be inserted into the tube. The assembly may then be heated to a forging temperature and internally upsetting the end portions of the tube around the mandrel such that the bore wall of the internal upset end portions of the tube comprise one or more grooves open to the bore of the tube.

The following portion of the summary is taken from the '495 reference and is applicable to this disclosure except as modified by FIGS. 1-5 and related text.

It is an object of this invention to provide a method of internally and externally upsetting the end of a tube to provide a thick wall for welding to a tool joint and to provide a long conical section (Miu) that has a radius of curvature at the intersection of the conical section and the inner wall of the tube of about 15″ or greater.

It is a further object of this invention to provide a method of internally and externally upsetting the metal tube to provide a thick end wall for welding to a tool joint that has a substantially longer Miu dimension than has been heretofore obtainable. As stated above, the Miu dimension is the projected length of the internal conical section connecting the internal upset cylindrical section to the unupset portion of the pipe measured along the center line of the pipe.

These and other objects, advantages, and features of this invention will be apparent to those skilled in the art from a consideration of this specification including the attached drawings and appended claims.

### BRIEF DESCRIPTION OF THE DRAWINGS

FIG. 1 is a cross section diagram of an embodiment of the present invention.

FIG. 2 is an axial cross section diagram of an upset embodiment of the present invention.

FIG. 3 is a cross section diagram of a method embodiment of the present invention.

FIG. 4 is an axial cross section diagram of a box end tool joint embodiment of the present invention.

FIG. 5 is an axial cross section diagram of a pin end tool joint embodiment of the present invention.

(Prior Art) FIGS. 6A-F show the steps of the upsetting process disclosed in U.S. Pat. No. 4,845,972.

(Prior Art) FIGS. 7A-D, show the four forging steps used in the method of this invention.

(Prior Art) FIG. 8 is a cross-section of the end of a 5″ diameter drill pipe tube internally and externally upset to the dimensions recommended by API.

(Prior Art) FIG. 9 is a cross-section of the end of a tube upset in accordance with the method of this invention.

(Prior Art) FIG. 10(A-C) graph showing where most drill pipe joint failures occur relative to the box end and the pin end of the joint.

(Prior Art) FIG. 11 is a sectional view on an enlarged scale showing the cross-sectional shape of the end of the tube before (in dashed lines) and after (solid lines) the third pressing pass or step.

(Prior Art) FIGS. 12A and 12B are computer produced stress plots of a 5″ tube internally and externally upset with a radius of curvature between internal cylindrical surface 60 and conical surface 62 of 0.5″ and an Miu length of 1.5″.

(Prior Art) FIGS. 13A and 13B are computer produced stress plots of a 5″ tube internally and externally upset with a radius of curvature between internal cylindrical surface 64 and conical surface 66 of 2.0″ and a Miu of 2.5″.

(Prior Art) FIGS. 14A and 14B are computer produced stress plots of a 5″ tube internally and externally upset using the method of this invention and having a radius of curvature between internal cylindrical surfaces 68 and conical surface 70 of 15″ and a Miu of 6.75″.

(Prior Art) FIG. 15 is a graph showing the relationship of upset fatigue life vs upset length (Miu-inches).

### DETAILED DESCRIPTION OF THE INVENTION

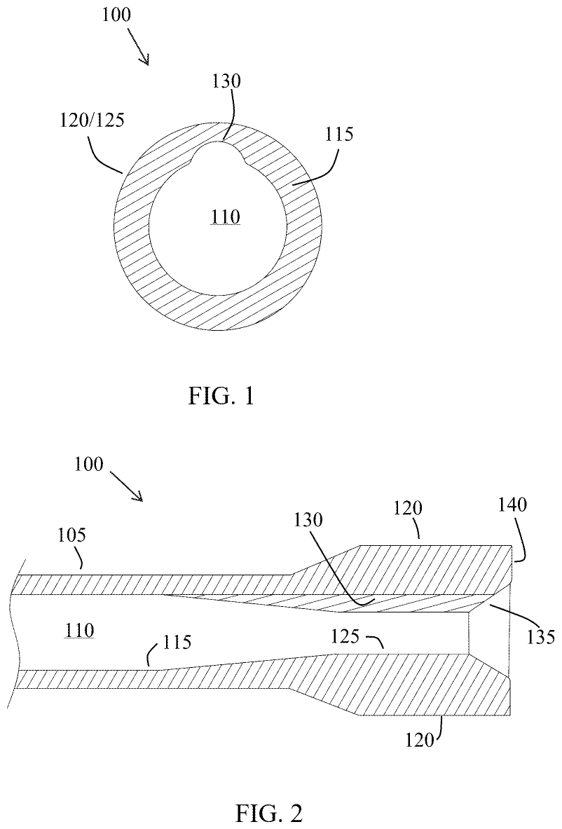

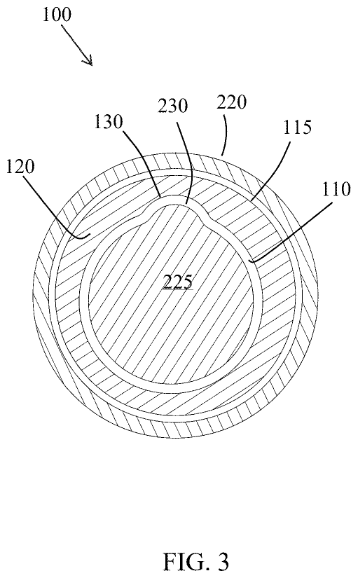

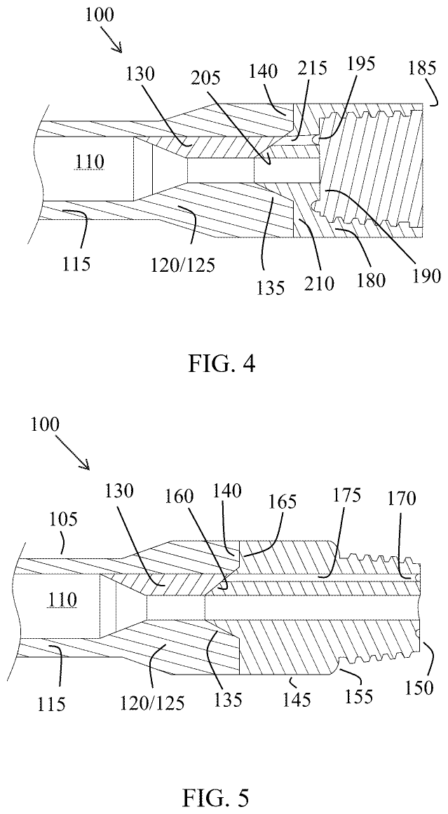

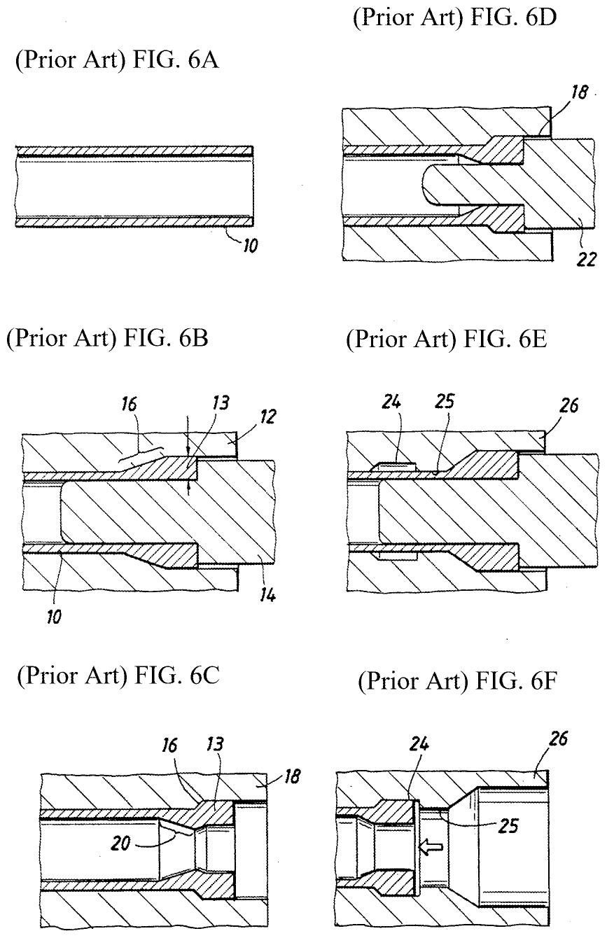

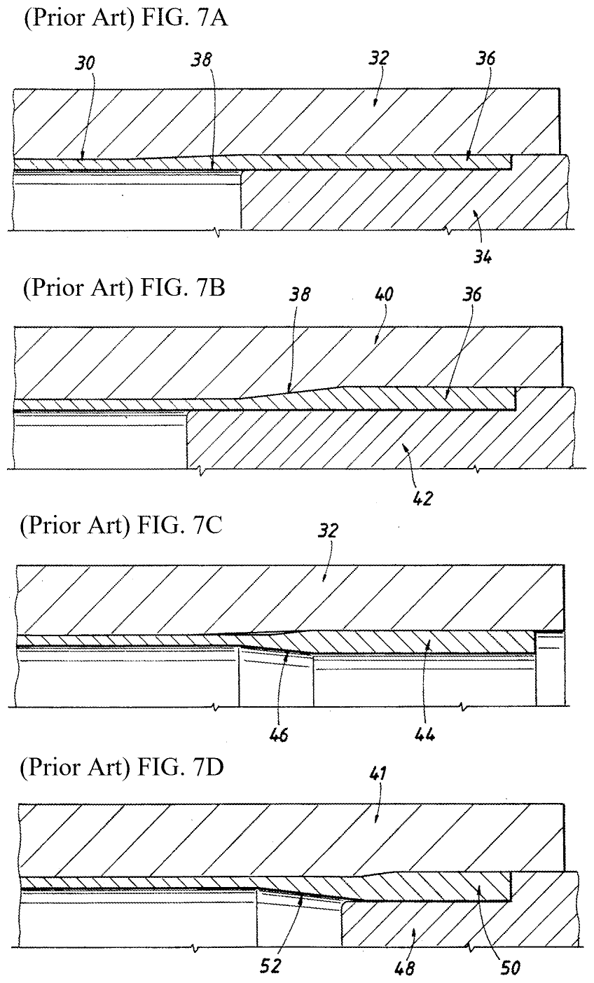

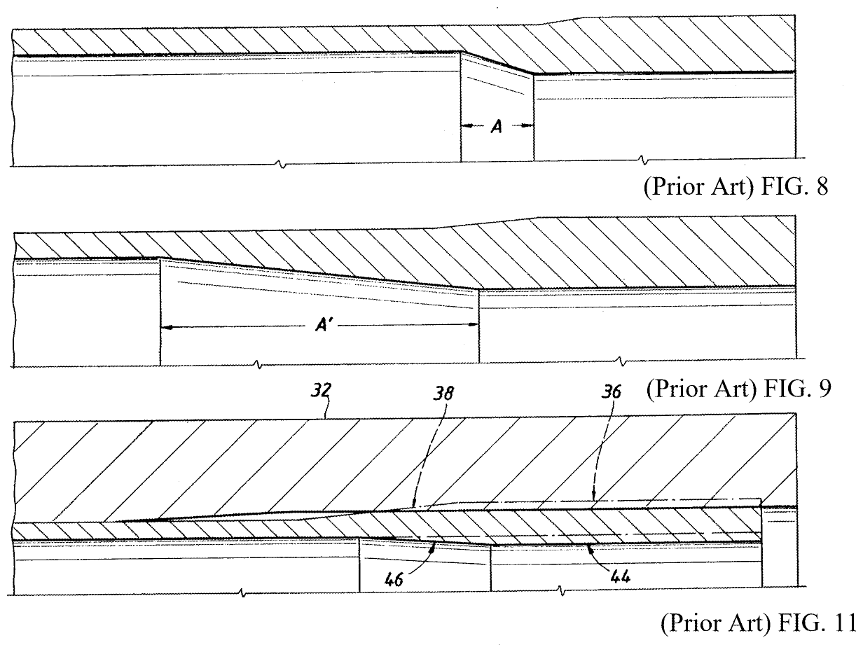

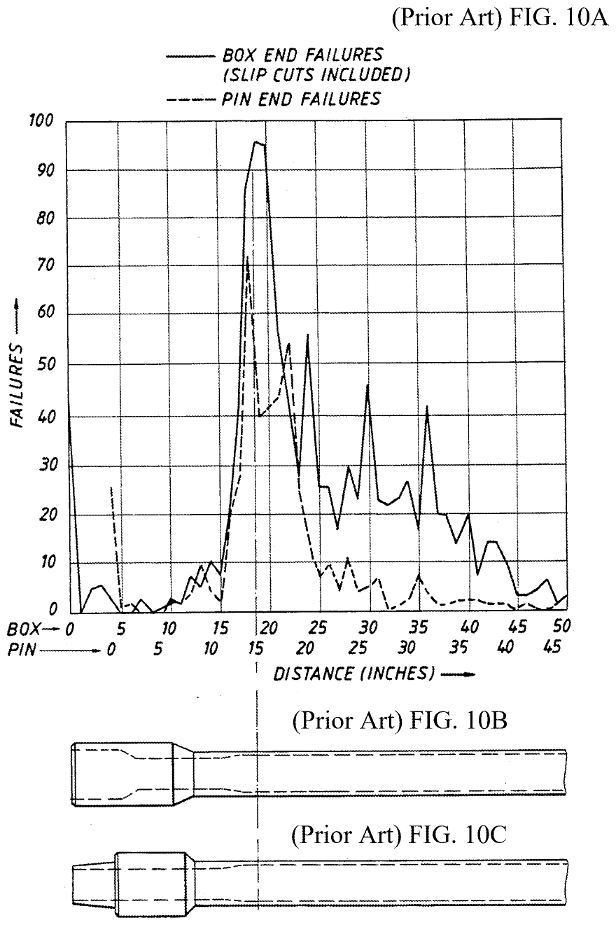

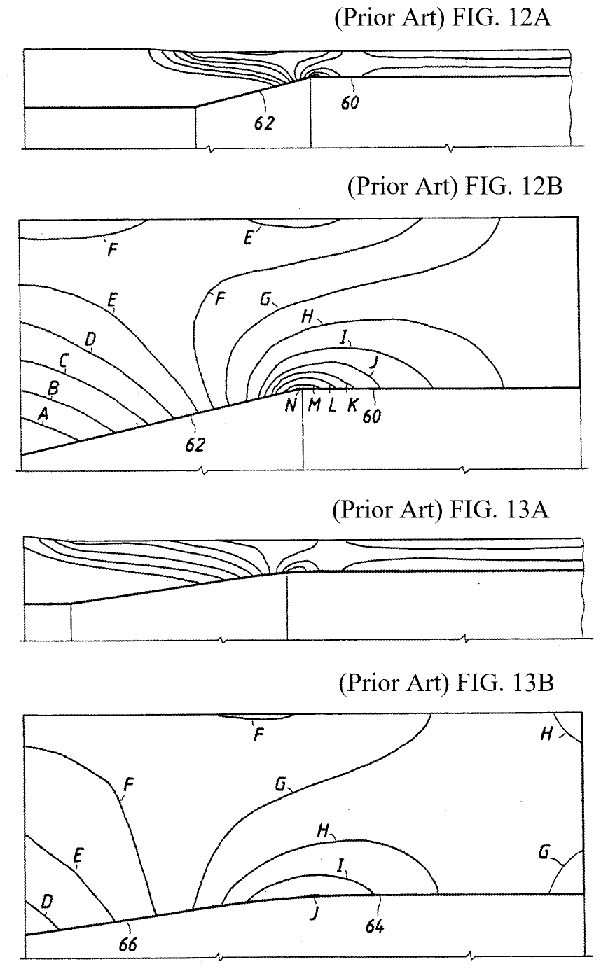

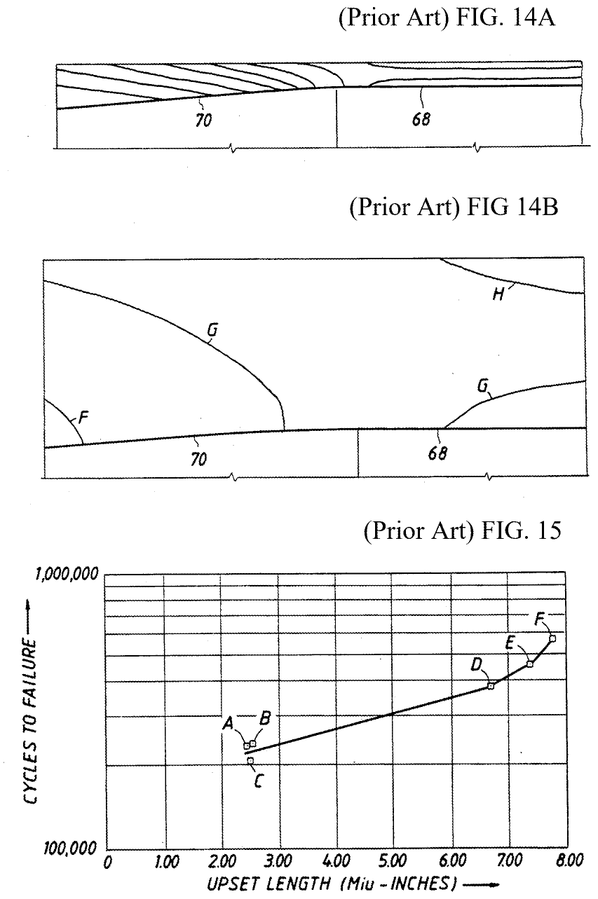

The following portion of the detailed description applies to FIGS. 1-5. FIGS. 1-5 present different diagrammatic views of embodiments of the present invention.

The present invention concerns a drill string tool 100 and method for producing same. The method may include providing a tube 105 comprising a central bore 110 and a central bore wall 115 suitable for use in a drill string tool 100, such as a drill pipe, riser, heavy weight drill pipe, drill collar, and downhole tools that may be found in the bottom hole assembly including drill bits connected to the drill string. Such tools may be fitted for wired drill pipe applications using inductive couplers and armored cables running the length of the individual drill string tools connecting the downhole tools with the surface electronics.

The tube 105 may comprise forming an annular external upset 120 in the bore wall of the opposing end portions of the tube 105. Additionally, the method may include forming an annular internal upset 125 in the bore wall 115 radially opposite the external upset 120. The internal upset 125 may comprise one or more axial grooves 130. The axial grooves 130 in the bore wall 115 may be open to the bore 110 of the tube 105. The axial grooves 130 may reduce the time and expense of manufacturing the tool 100. The axial grooves may provide a pathway for an armored cable (not shown) to enter the bore 110 of the tube 105 as the armored cable exits the passageway 175/215 of a tool joint 145/180 that may be attached to the tube 105.

The internal upset 125 in the bore wall 115 may comprise a conical weld surface 135 comprising an annular shoulder 140. The conical weld surface 135 and shoulder 140 may aid in the attachment of the tube 105 to the tool joints 180/145. The conical weld surface 135 and the annular shoulder 140 may increase the strength of the weld connection between the tool joints and the upset portion of the tube 105. The conical weld surface combined with the annular shoulder may also promote competent friction welding and reduce the amount of weld flash produced in the welding process. The conical weld surface 135 may intersect the bore 110 and bore wall 115, the internal and external upset portions of the tube 105, and the one or more axial grooves 130.

An embodiment of the disclosed tool 100 may include providing a pin end tool joint 145 comprising a primary annular shoulder 155 and an annular secondary shoulder 150. The shoulder 150 may comprise an annular groove 170 communicating with an axial passageway 175 within the tool joint 145. The axial passageway 175 may lead to the axial groove 130 providing access to the bore 110 of the tube 105.

The pin end tool joint 145 may further comprise a conical weld surface 160 comprising an annular shoulder 165. The respective conical weld surfaces 160/165 may mate with the respective conical weld surfaces 135/140 of the upset portions of the tube 105 as the tube 105 is attached to the pin end tool joint 145.

The tube 105 may comprise a pin end tool joint 145 on one end of the tube 105 and box end tool joint 180 on the opposite end of the tube 105. The respective tool joints aid in incorporating the downhole tool 100 in a tool string. The box end tool joint 180 may comprise a primary annular shoulder 185 and an annular secondary shoulder 190 comprising an annular groove 195 communicating with an axial passageway 215 within the tool joint 180. The annular groove 195 and the axial passageway may facilitate the addition of wired drill pipe components to the downhole tool. Accordingly, the annular grooves 195/170 may house and inductive coupler system for the electromagnetic transfer of power and data between connected tool string components. The axial passageway 175/215 may provide a pathway for an armored cable to run from the inductive coupler system to a like system at the opposite end of the drill string tool.

The box end tool joint 180 further may comprise a conical weld surface 205 comprising an annular shoulder 210. The conical weld surfaces 205/210 may aid in strengthening the attachment of the tool joint 180 to the upset portion 120/125 of the tube 105. The respective conical weld surfaces may promote the attachment of the tool joint to the tube. The conical weld surfaces may reduce the amount of flash produced in the attachment process.

The respective tool joints 145/180 may be attached along the conical weld surfaces 160/205 and the annular shoulders 140/210 to the respective upset end portions of the tube 105 in such a manner that the axial passageways 175/215 are aligned with the one or more open grooves 130 in the upset end portions 120/125 of the tube 105. The alignment of the axial passageways with the grooves may aid in the manufacturer of the tool 100. The alignment may reduce the amount time and expense otherwise associated with gun drilling an extended length passageway in the bore wall after the respective tool joints are welded to tube. In the event that the axial passageways 175/215 are not aligned with the groove 130, the presence of the axial passageways may still reduce the cost of manufacturing by eliminating the substantial amount of time and expense required in gun drilling through tool joint. Also, the axial passageway may provide a guide for drilling through the upset potion of the tube.

In aligning the axial passageways with the grooves while the respective upset end portions of the tube 120/125 are friction welded along the conical weld surfaces 160/205 and respective shoulders 140/210 to the respective tool joints 145/180, the friction welding may be selectively terminated when the passageways 175/215 and the respective one or more grooves 130 are aligned. The selective termination of the welding process may be achieved by monitoring the rotation and time of rotation of the tube and tool joint, the pressure required in the process, as well as the color of the weld surfaces. The color of the weld surfaces may indicate when the weld process is sufficiently complete to terminate the process. The production of weld flash may also indicate when the weld process may be completed.

The one or more grooves 130 in the upset end portions 120/125 of the tube 105 may be formed by machining the internal upset 125 prior to the attachment of the tube 105 to the tool joints 145/180. Machining the internal upset 125 may include milling, drilling, broaching, grinding, sawing, or a combination thereof.

Alternatively, the one or more grooves 130 may be formed in the internal upset 125 portion of the tube when the upset 125 is forged. For example, an assembly comprising a tube 105 comprising externally upset end portions 120, an internal upset die 220, and an internal upset mandrel 225 comprising one or more axial lobes 230 may be used to form the one or more axial grooves 130 when the internal upset is forged. The external upset portion of the tube may be inserted into the internal upset die 220 and the mandrel 225 may be inserted into the tube 105. The assembly may then be heated to a forging temperature and internally upsetting the end portions 125 of the tube 105 around the mandrel 225 such that the bore wall 115 of the internal upset end portions 125 of the tube 105 comprise one or more grooves 130 open to the bore 110 of the tube 105.

The following portion of the detailed description is taken from the '495 reference and is applicable to this disclosure except as modified by FIGS. 1-5 and related text. The '004 reference is also applicable to this detailed description.

The two methods disclosed in the prior art '972 patent are shown in (Prior Art) FIG. 6. (Prior Art) FIG. 6A is just a cross-section of the end of the tube to be upset. The first step of the first method described in the patent is shown in (Prior Art) FIG. 6B where die 12 and mandrel 14 combine to force the metal adjacent the end of the tube outwardly to form cylindrical section 13 having a wall with the thickness A. Cylindrical section 13 is connected to the non-upset portion of tube 10 through conical transition section 16.

The second step of the first method is shown in (Prior Art) FIG. 6C. Here second die 18 is used to press a portion of the metal in conical transition section 16 and a portion of cylindrical section 13 inwardly to form conical section 20 on the inside of the tube that connects the portion of the metal of cylindrical section 13 that has been forced inwardly by die 18 to create an internal upset of the tube. The final step of the first method of the '972 patent is shown in (Prior Art) FIG. 6D. The same die 18 is used and the final shape of the end of the tube is formed by die 18 and mandrel 22.

(Prior Art) FIGS. 6E and 6F show an alternate process where the end of the tube is externally upset as shown in (Prior Art) FIG. 6E. The patent says this is accomplished using die 18 as shown in (Prior Art) FIGS. 6(C) and 6(D), but they don't look like the same die. In fact, die 26 shown in (Prior Art) FIGS. 6(E) and 6(F) appear to be the same. In the second and final step the end of the tube is forced through restriction 25, after which it expands outwardly into groove 24.

The method of this invention in shown in (Prior Art) FIGS. 7A-D. (Prior Art) FIG. 7A shows the first step of the method in which the end of tube 30 is externally upset using die 32 and mandrel 34. In this step, cylindrical section 36 of the tube wall adjacent the end of the tube is increased in thickness and conical section 38 is formed to provide the transition between cylindrical section 36 of increased diameter and the tube. In the second step shown in (Prior Art) FIG. 7B, die 40 combines with mandrel 42 to increase the thickness of cylindrical section 36 which, of course, increases the angle of the taper of conical section 38.

After the second step, the end of the tube is reheated to the original forging temperature (about 2200.degree. F.) after which it is subjected to the third step of the process. As shown in (Prior Art) FIG. 7C, die 32 (the same die that is used in the first step) is used alone in this step to press the metal inwardly that had been moved outwardly in steps 1 and 2. Before the die is closed, however, the tube is moved axially to the right to position cylindrical section 36 and conical section 38 in the cylindrical section of the die. This results in cylindrical section 44 having inside and outside diameters that are less than that of section 36 and a conical section 46 having a long tapered internal surface extending between the internal wall of cylindrical section 44 and the non-upset tube wall.

In the final and fourth step, shown in (Prior Art) FIG. 7D, mandrel 48 combines with fourth step die 4 to shorten cylindrical section 44 thereby forming cylindrical section 50 having a thicker wall and smaller inside diameter and conical section 52 having a longer internal taper than conical section 46.

The shape of the end result of the four steps just described is shown in (Prior Art) FIG. 9 on a larger scale. The dimension shown both on (Prior Art) FIG. 9 and the API joint of (Prior Art) FIG. 8 are for 5″, 19.5 lbs. per foot, drill pipe. Using Applicant's method of upsetting, the Miu dimension is shown as 4½″, which is a minimum dimension. The average Miu length produced by the method of this invention is much greater. A random check of 5″ tubes upset using the method of this invention, showed an average Miu length of 6.725″ with a radius of curvature over 15″. In fact, some of the 5″ O.D. tubes had a radius of curvature up to 48″.

It is believed that the longer Miu length results because two steps are used to initially upset the tube externally thereby gathering more metal for pressing inwardly in the third step, which step is further aided by again heating the metal to forging temperature. In (Prior Art) FIG. 11, the shape of the end of the tube before and after the third pass or step for a 5″, 19.5 lbs. per foot drill pipe is shown approximately to scale.

(Prior Art) FIGS. 12A-14B show the stress patterns produced in three externally-internally upset joints of 5″ diameter S-135 drill pipe. Each joint was rotated at 258 rpm while subjected to a lateral force 17″ below the elevator taper on the tool joint that created a stress of 35,400 psi in the tube portion of the joint. A force of around 2,240 lbs. was required. The computer was programmed for the letter “O” to indicate stresses of 48,000 psi and above. Each preceding letter was programmed to indicate a stress reduction of 2,000 psi. Thus, “A” indicates a stress reduction of 20,000 psi, “B” a stress of 22,000 psi and so on.

(Prior Art) FIG. 15 shows the cycles to failure for three API internal-external upset drill pipe joints and three external-internal upset drill pipe joints using the method of this invention. Joints A,B, and C are the former and D,E, and F the latter.

Joints A, B, and C failed after 237,618, 235,296, and 205,884 cycles, respectfully. Joint D had a Miu taper of 6 11/16″. It failed after 382,666 cycles. Joint E had a taper of 7⅜″ and failed after 462,028 cycles. Joint F had a taper of 7¾ and failed after 569,664 cycles.

From the foregoing it will be seen that this invention is one well adapted to attain all of the ends and objects hereinabove set forth, together with other advantages which are obvious and which are inherent to the method.

1. A drill string tool and method, comprising:
providing a tube comprising a central bore and a central bore wall suitable for use in a drill string tool;
forming an annular external upset in the bore wall of the opposing end portions of the tube;
forming an annular internal upset in the bore wall radially opposite the external upset comprising one or more axial grooves, wherein
the axial grooves in the bore wall are open to the bore of the tube.

2. The method of claim 1, wherein the internal upset further comprises a conical weld surface comprising an annular shoulder intersecting the bore and bore wall of the tube and the one or more axial grooves.

3. The method of claim 1, providing a pin end tool joint comprising a secondary shoulder comprising an annular groove communicating with an axial passageway within the tool joint.

4. The method of claim 1, wherein the pin end tool joint further comprises a conical weld surface comprising an annular shoulder.

5. The method of claim 1, providing a box end tool joint comprising a secondary shoulder comprising an annular groove communicating with an axial passageway within the tool joint.

6. The method of claim 1, wherein the box end tool joint further comprises a conical weld surface comprising an annular shoulder.

7. The method of claim 1, wherein the respective tool joints are attached along the conical weld surfaces and the annular shoulders to the respective upset end portions of the tube in such a manner that the axial passageways are aligned with the one or more open grooves in the upset end portions of the tube.

8. The method of claim 1, wherein the respective upset end portions of the tube are friction welded along the conical weld surfaces and respective shoulders to the respective tool joints and the friction welding is selectively terminated when the passageways and the respective one or more grooves are aligned.

9. A drill string tool and method, comprising:
providing a tube comprising externally upset end portions;
providing an internal upset die;
inserting the externally upset end portions of the tube into the upset die;
providing an internal upset mandrel comprising one or more external axial lobes;
inserting the internal upset mandrel into the externally upset end portions of the tube;
heating the upset end portions to a forging temperature, and
internally upsetting the end portions of the tube around the mandrel such that the bore wall of the upset end portions of the tube comprise one or more grooves open to the bore of the tube.

10. The method of claim 9, wherein the internal upset further comprises a conical weld surface comprising an annular shoulder intersecting the bore and bore wall of the tube and the one or more axial grooves.

11. The method of claim 9, providing a pin end tool joint comprising a secondary shoulder comprising an annular groove communicating with an axial passageway within the tool joint.

12. The method of claim 9, wherein the pin end tool joint further comprises a conical weld surface comprising an annular shoulder.

13. The method of claim 9, providing a box end tool joint comprising a secondary shoulder comprising an annular groove communicating with an axial passageway within the tool joint.

14. The method of claim 9, wherein the box end tool joint further comprises a conical weld surface comprising an annular shoulder.

15. The method of claim 9, wherein the respective tool joints are attached along the conical weld surfaces and annular shoulders to the respective upset end portions of the tube in such a manner that the axial passageways are aligned with the one or more open grooves in the upset end portions of the tube.

16. The method of claim 9, wherein the respective upset end portions of the tube are friction welded to the respective tool joints and the friction welding is selectively terminated when the passageways and the respective one or more grooves are aligned.

17. The method of claim 1, wherein the axial passageway comprises one or more flutes.

18. The method of claim 1, wherein the axial passageway comprises one or more flute inserts.

19. The method of claim 9, wherein the axial passageway comprises one or more flutes.

20. The method of claim 9, wherein the axial passageway comprises one or more flute inserts.
